(19) United States
(12) Patent Application Publication
(10) Pub. No.: US 2017/0293903 A1
(43) Pub. Date: Oct. 12, 2017

(54) Commercial accounts for digital download

(71) Applicant: Michael Lewis Moravitz, Fairfax, VA (US)

(72) Inventor: Michael Lewis Moravitz, Fairfax, VA (US)

(21) Appl. No.: 14/999,199

(22) Filed: Apr. 11, 2016

(51) Int. Cl. G06Q 20/12; H04W 4/00; G06Q 20/18

(52) U.S. Cl. CPC G06Q 20/123; G06Q 20/18; H04W 4/003

(57) ABSTRACT

Commercial accounts should be set up by ITunes and other providers of digital sound and video for businesses to sell the products within stores, avoiding the inefficiency of preloaded MP3 players and increasing the availability of these products to those without Internet access or with not enough bandwidth.

Not everyone has access to the Internet nor do they necessarily have enough bandwidth to download music. The preloaded IPod is wasteful—especially given the amount of music that is provided on it.

The Store Downloader patent application of mine would allow stores—including chains and small, independent businesses—to have a high-speed terminal for people to plug their MP3 player to and buy music from the terminal. The store owner would gain a fee—as well as customers coming to his or her establishment—and the company providing the music would as well. Businesses could set these terminals up with commercial accounts. Even an independent business might set up a terminal, connect on the Internet to Itunes, Amazon.com, or some other provider of digital music, books, or video and through a commercial account for that business, a customer would be able to make his or her purchase. This is not just a marketing scheme but a whole way of doing business through high-speed terminals at businesses—including gathering places, chain stores, music venues, etc. Local bands or classical ensembles, or any other artistic group might provide its material through this commercial account that links to local business or franchises. This breaks through compatibility issues in the Internet era and makes music and video more available to customers—while making it pay more for their artists rather than free podcasts and downloads.

1) Builds on my previous patent for Store Downloader (Ser. No. 14/120,022);

2) ITunes software and digital download service system; and

3) Other digital download service software and systems.
